(19) United States
(12) Patent Application Publication
(10) Pub. No.: US 2016/0266682 A1
(43) Pub. Date: Sep. 15, 2016

(54) FORCE SENSOR

(71) Applicant: Synaptics Incorporated, San Jose, CA (US)

(72) Inventors: Chih-Yin Fu, San Jose, CA (US); Xuming Zeng, San Jose, CA (US); Richard Schediwy, Union City, CA (US); Doug Krumpelman, Coeur d'Alene, ID (US); Hsiao-Lan Hsu, San Jose, CA (US); Chieh-Feng Tu, San Jose, CA (US)

(21) Appl. No.: 15/068,691

(22) Filed: Mar. 14, 2016

Related U.S. Application Data
(60) Provisional application No. 62/132,439, filed on Mar. 12, 2015.

(51) Int. Cl. G06F 3/044; G06F 3/041

(52) U.S. Cl. CPC G06F 3/044; G06F 3/0414

(57) ABSTRACT

An input device may include various sensor electrodes that detect positional information of an input object in a sensing region of the input device. The input device may include a first sensor electrode that detects a first change in a first variable capacitance in response to a deflection of a conductive layer by the input object. The input device may include a second sensor electrode that detects a second change in a second variable capacitance in response to the deflection of the conductive layer by the input object. The first change in the first variable capacitance and the second change in the second variable capacitance may determine an acquired force image of the input force. An adjusted force image may be determined from the acquired force image using the positional information.

### CROSS-REFERENCE TO RELATED APPLICATIONS

This application claims priority to U.S. Provisional Patent Application Ser. No. 62/132,439, which was filed on Mar. 12, 2015, and is incorporated herein by reference.

### FIELD

This invention generally relates to electronic devices.

### BACKGROUND

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

### SUMMARY

In general, in one aspect, the invention relates to a processing system for an input device. The processing system includes sensor circuitry communicatively coupled to various position sensor electrodes, a first force sensor electrode, and a second force sensor electrode. The processing system further includes a sensor module that obtains a first capacitance measurement from the first force sensor electrode and a second capacitance measurement from the second force sensor electrode. The first capacitance measurement and the second capacitance measurement correspond to changes in a variable capacitance in response to a deflection of the first force sensor electrode and the second force sensor electrode by an input force. The input force is applied by at least one input object to an input surface of the input device. The sensor module further obtains, from the position sensor electrodes, positional information of the at least one input object in a sensing region of the input device. The processing system further includes a determination module that determines, using the first capacitance measurement and the second capacitance measurement, an acquired force image of the input force. The determination module further determines, using the acquired force image and the positional information, an adjusted force image of the input force.

In general, in one aspect, the invention relates to an electronic system. The electronic system includes a display that presents information to a user. The electronic system further includes an input surface and an input device that includes various position sensor electrodes, a first force sensor electrode, and a second force sensor electrode. The electronic system further includes a processing system communicatively coupled to the display and the input device. The processing system obtains a first capacitance measurement from the first force sensor electrode and a second capacitance measurement from the second force sensor electrode. The first capacitance measurement and the second capacitance measurement correspond to changes in a variable capacitance in response to a deflection of the first force sensor electrode and the second force sensor electrode by an input force. The input force is applied by at least one input object to an input surface of the input device. The processing system further obtains, from the position sensor electrodes, positional information of the at least one input object in a sensing region of the input device. The processing system further determines, using the first capacitance measurement and the second capacitance measurement, an acquired force image of the input force. The processing system further determines, using the acquired force image and the positional information, an adjusted force image of the input force.

In general, in one aspect, the invention relates to an input device. The input device includes various sensor electrodes that detect positional information of at least one input object in a sensing region of the input device. The input device further includes a first sensor electrode that detects a first change in a first variable capacitance in response to a deflection of a conductive layer by at least one input object. The input device further includes a second sensor electrode that detects a second change in a second variable capacitance in response to the deflection of the conductive layer by the at least one input object. The first change in the first variable capacitance and the second change in the second variable capacitance determine an acquired force image of the input force. An adjusted force image is determined from the acquired force image using the positional information.

Other aspects of the invention will be apparent from the following description and the appended claims.

### BRIEF DESCRIPTION OF DRAWINGS

FIG. 1 shows a block diagram in accordance with one or more embodiments.

FIGS. 2.1 and 2.2 show schematic diagrams in accordance with one or more embodiments.

FIGS. 3.1, 3.2, and 3.3 show schematic diagrams in accordance with one or more embodiments.

FIG. 4 shows a flowchart in accordance with one or more embodiments.

FIGS. 5.1, 5.2, and 5.3 show examples of capacitance diagrams in accordance with one or more embodiments.

FIG. 6 shows a flowchart in accordance with one or more embodiments.

FIGS. 7.1, 7.2, and 7.3 show examples in accordance with one or more embodiments.

FIGS. 8.1 and 8.2 show a computing system in accordance with one or more embodiments

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Various embodiments provide input devices and methods that facilitate improved usability. In particular, one or more embodiments are directed to a method that detects an input force using various force sensor electrodes. In one or more embodiments, for example, the force sensor electrodes are located in the display of an electronic system and measure a change in capacitance with a reference voltage substrate in the electronic system. In one or more embodiments, for example, an acquired force image is produced using raw capacitance measurements obtained from these force sensor electrodes. The raw capacitance measurements may be processed using positional information to produce an adjusted force image. From the adjusted force image, force information may be calculated and used by an electronic system. For example, the force information may be used to determine a command or signal for an interface action or other action performed by an electronic system.

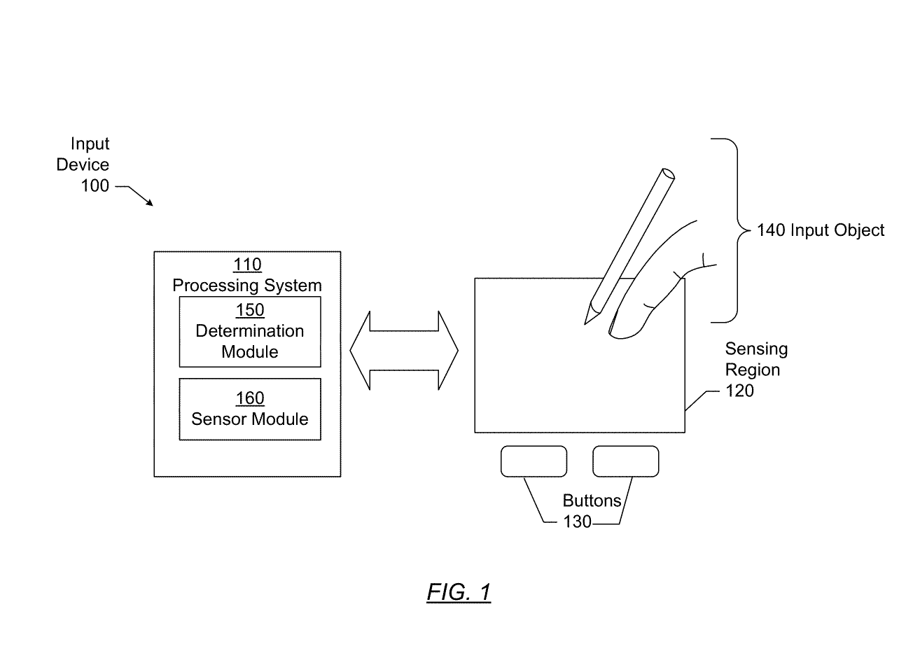

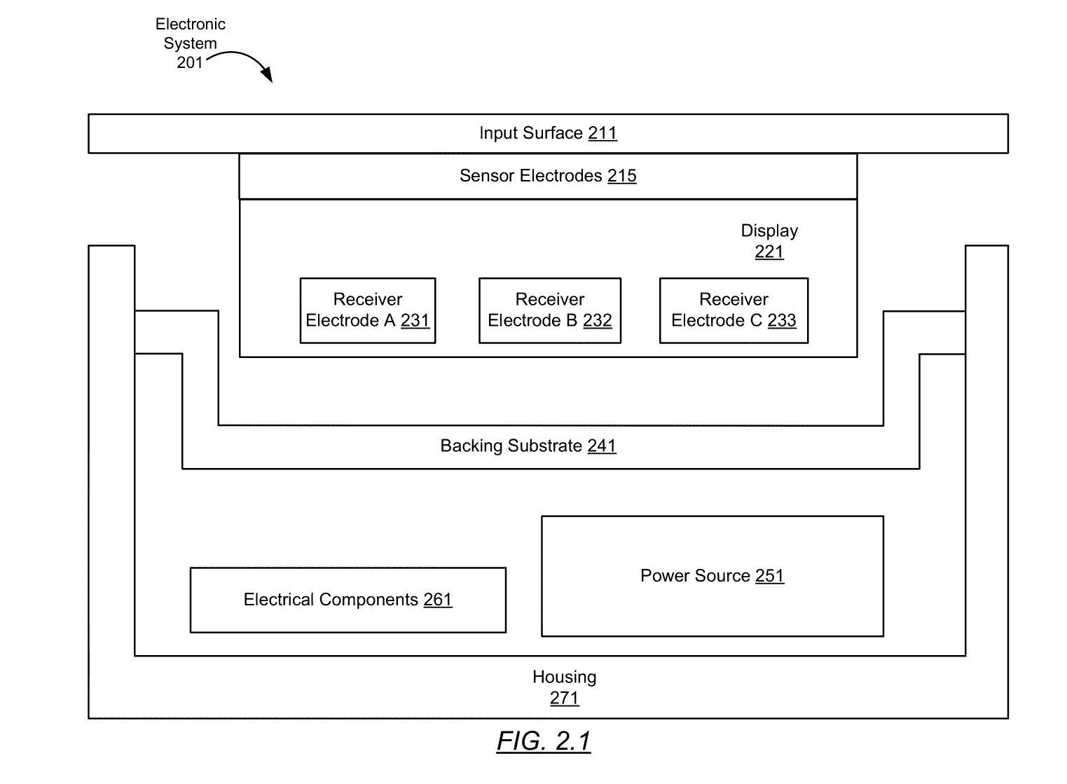

Turning now to the figures, FIG. 1 is a block diagram of an exemplary input device (100), in accordance with embodiments of the invention. The input device (100) may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device (100) and separate joysticks or key switches. Further example electronic systems include peripherals, such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device (100) may be implemented as a physical part of the electronic system, or may be physically separate from the electronic system. Further, portions of the input device (100) as part of the electronic system. For example, all or part of the determination module may be implemented in the device driver of the electronic system. As appropriate, the input device (100) may communicate with parts of the electronic system using any one or more of the following: buses, networks, and other wired or wireless interconnections. Examples include I2C, SPI, PS/2, Universal Serial Bus (USB), Bluetooth, RF, and IRDA.

In FIG. 1, the input device (100) is shown as a proximity sensor device (also often referred to as a “touchpad” or a “touch sensor device”) configured to sense input provided by one or more input objects (140) in a sensing region (120). Example input objects include fingers and styli, as shown in FIG. 1. Throughout the specification, the singular form of input object is used. Although the singular form is used, multiple input objects exist in the sensing region (120). Further, which particular input objects are in the sensing region may change over the course of one or more gestures. For example, a first input object may be in the sensing region to perform the first gesture, subsequently, the first input object and a second input object may be in the above surface sensing region, and, finally, a third input object may perform the second gesture. To avoid unnecessarily complicating the description, the singular form of input object is used and refers to all of the above variations.

The sensing region (120) encompasses any space above, around, in and/or near the input device (100) in which the input device (100) is able to detect user input (e.g., user input provided by one or more input objects (140)). The sizes, shapes, and locations of particular sensing regions may vary widely from embodiment to embodiment.

In some embodiments, the sensing region (120) extends from a surface of the input device (100) in one or more directions into space until signal-to-noise ratios prevent sufficiently accurate object detection. The extension above the surface of the input device may be referred to as the above surface sensing region. The distance to which this sensing region (120) extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device (100), contact with an input surface (e.g. a touch surface) of the input device (100), contact with an input surface of the input device (100) coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region (120) has a rectangular shape when projected onto an input surface of the input device (100).

The input device (100) may utilize any combination of sensor components and sensing technologies to detect user input in the sensing region (120). The input device (100) includes one or more sensing elements for detecting user input. As several non-limiting examples, the input device (100) may use capacitive, elastive, resistive, inductive, magnetic, acoustic, ultrasonic, and/or optical techniques.

Some implementations are configured to provide images that span one, two, three, or higher dimensional spaces. Some implementations are configured to provide projections of input along particular axes or planes. Further, some implementations may be configured to provide a combination of one or more images and one or more projections.

In some resistive implementations of the input device (100), a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device (100), one or more sensing elements pick up loop currents induced by a resonating coil or pair of coils. Some combination of the magnitude, phase, and frequency of the currents may then be used to determine positional information.

In some capacitance implementations of the input device (100), voltage or current is applied to create an electric field. Nearby input objects cause changes in the electric field, and produce detectable changes in capacitive coupling that may be detected as changes in voltage, current, or the like.

Some capacitance implementations utilize arrays or other regular or irregular patterns of capacitive sensing elements to create electric fields. In some capacitance implementations, separate sensing elements may be ohmically shorted together to form larger sensor electrodes. Some capacitance implementations utilize resistive sheets, which may be uniformly resistive.

Some capacitance implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g., system ground), and by detecting the capacitive coupling between the sensor electrodes and input objects. The reference voltage may by a substantially constant voltage or a varying voltage and in various embodiments; the reference voltage may be system ground. Measurements acquired using absolute capacitance sensing methods may be referred to as absolute capacitive measurements.

Some capacitance implementations utilize “mutual capacitance” (or “trans capacitance”) sensing methods based on changes in the capacitive coupling between sensor electrodes. In various embodiments, an input object near the sensor electrodes alters the electric field between the sensor electrodes, thus changing the measured capacitive coupling. In one implementation, a mutual capacitance sensing method operates by detecting the capacitive coupling between one or more transmitter sensor electrodes (also “transmitter electrodes” or “transmitter”) and one or more receiver sensor electrodes (also “receiver electrodes” or “receiver”). Transmitter sensor electrodes may be modulated relative to a reference voltage (e.g., system ground) to transmit transmitter signals (also called “sensing signal”). Receiver sensor electrodes may be held substantially constant relative to the reference voltage to facilitate receipt of resulting signals. The reference voltage may by a substantially constant voltage and in various embodiments; the reference voltage may be system ground. In some embodiments, transmitter sensor electrodes may both be modulated. The transmitter electrodes are modulated relative to the receiver electrodes to transmit transmitter signals and to facilitate receipt of resulting signals. A resulting signal may include effect(s) corresponding to one or more transmitter signals, and/or to one or more sources of environmental interference (e.g. other electromagnetic signals). The effect(s) may be the transmitter signal, a change in the transmitter signal caused by one or more input objects and/or environmental interference, or other such effects. Sensor electrodes may be dedicated transmitters or receivers, or may be configured to both transmit and receive. Measurements acquired using mutual capacitance sensing methods may be referred to as mutual capacitance measurements.

Further, the sensor electrodes may be of varying shapes and/or sizes. The same shapes and/or sizes of sensor electrodes may or may not be in the same groups. For example, in some embodiments, receiver electrodes may be of the same shapes and/or sizes while, in other embodiments, receiver electrodes may be varying shapes and/or sizes.

In FIG. 1, a processing system (110) is shown as part of the input device (100). The processing system (110) is configured to operate the hardware of the input device (100) to detect input in the sensing region (120). The processing system (110) includes parts of or all of one or more integrated circuits (ICs) and/or other circuitry components. For example, a processing system for a mutual capacitance sensor device may include transmitter circuitry configured to transmit signals with transmitter sensor electrodes, and/or receiver circuitry configured to receive signals with receiver sensor electrodes. Further, a processing system for an absolute capacitance sensor device may include driver circuitry configured to drive absolute capacitance signals onto sensor electrodes, and/or receiver circuitry configured to receive signals with those sensor electrodes. In one more embodiments, a processing system for a combined mutual and absolute capacitance sensor device may include any combination of the above described mutual and absolute capacitance circuitry. In some embodiments, the processing system (110) also includes electronically-readable instructions, such as firmware code, software code, and/or the like. In some embodiments, components composing the processing system (110) are located together, such as near sensing element(s) of the input device (100). In other embodiments, components of processing system (110) are physically separate with one or more components close to the sensing element(s) of the input device (100), and one or more components elsewhere. For example, the input device (100) may be a peripheral coupled to a computing device, and the processing system (110) may include software configured to run on a central processing unit of the computing device and one or more ICs (perhaps with associated firmware) separate from the central processing unit. As another example, the input device (100) may be physically integrated in a mobile device, and the processing system (110) may include circuits and firmware that are part of a main processor of the mobile device. In some embodiments, the processing system (110) is dedicated to implementing the input device (100). In other embodiments, the processing system (110) also performs other functions, such as operating display screens, driving haptic actuators, etc.

The processing system (110) may be implemented as a set of modules that handle different functions of the processing system (110). Each module may include circuitry that is a part of the processing system (110), firmware, software, or a combination thereof. In various embodiments, different combinations of modules may be used. For example, as shown in FIG. 1, the processing system (110) may include a determination module (150) and a sensor module (160). The determination module (150) may include functionality to determine when at least one input object is in a sensing region, determine signal to noise ratio, determine positional information of an input object, identify a gesture, determine an action to perform based on the gesture, a combination of gestures or other information, and/or perform other operations.

The sensor module (160) may include functionality to drive the sensing elements to transmit transmitter signals and receive the resulting signals. For example, the sensor module (160) may include sensory circuitry that is coupled to the sensing elements. The sensor module (160) may include, for example, a transmitter module and a receiver module. The transmitter module may include transmitter circuitry that is coupled to a transmitting portion of the sensing elements. The receiver module may include receiver circuitry coupled to a receiving portion of the sensing elements and may include functionality to receive the resulting signals.

Although FIG. 1 shows a determination module (150) and a sensor module (160), alternative or additional modules may exist in accordance with one or more embodiments of the invention. Such alternative or additional modules may correspond to distinct modules or sub-modules than one or more of the modules discussed above. Example alternative or additional modules include hardware operation modules for operating hardware such as sensor electrodes and display screens, data processing modules for processing data such as sensor signals and positional information, reporting modules for reporting information, and identification modules configured to identify gestures, such as mode changing gestures, and mode changing modules for changing operation modes. Further, the various modules may be combined in separate integrated circuits. For example, a first module may be comprised at least partially within a first integrated circuit and a separate module may be comprised at least partially within a second integrated circuit. Further, portions of a single module may span multiple integrated circuits. In some embodiments, the processing system as a whole may perform the operations of the various modules.

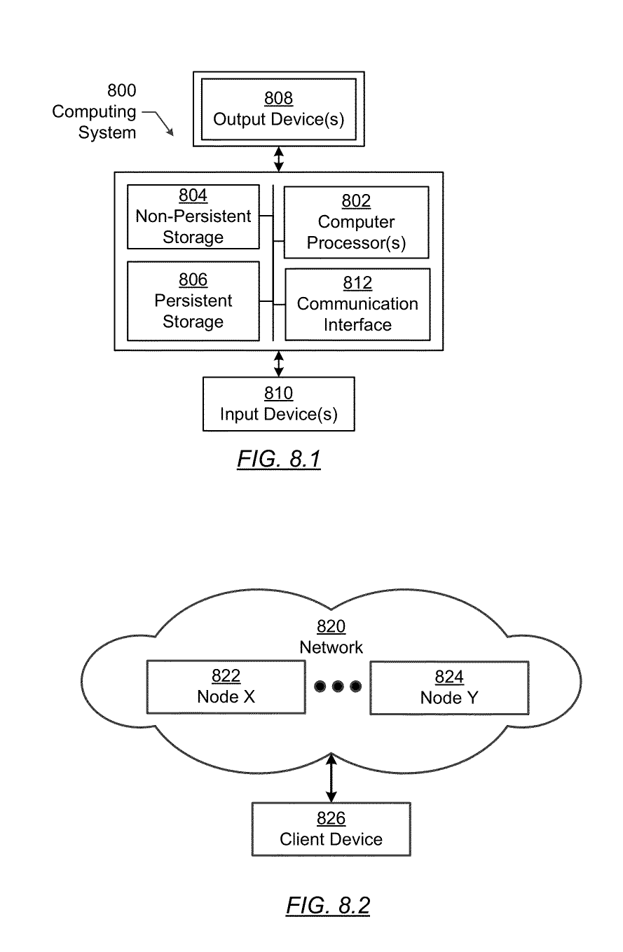

In some embodiments, the processing system (110) responds to user input (or lack of user input) in the sensing region (120) directly by causing one or more actions. Example actions include changing operation modes, as well as graphical user interface (GUI) actions such as cursor movement, selection, menu navigation, and other functions. In some embodiments, the processing system (110) provides information about the input (or lack of input) to some part of the electronic system (e.g. to a central processing system of the electronic system that is separate from the processing system (110), if such a separate central processing system exists). In some embodiments, some part of the electronic system processes information received from the processing system (110) to act on user input, such as to facilitate a full range of actions, including mode changing actions and GUI actions. In one or more embodiments, the electronic system includes one or more components as described in FIGS. 8.1 and 8.2.

For example, in some embodiments, the processing system (110) operates the sensing element(s) of the input device (100) to produce electrical signals indicative of input (or lack of input) in the sensing region (120). The processing system (110) may perform any appropriate amount of processing on the electrical signals in producing the information provided to the electronic system. For example, the processing system (110) may digitize analog electrical signals obtained from the sensor electrodes. As another example, the processing system (110) may perform filtering or other signal conditioning. As yet another example, the processing system (110) may subtract or otherwise account for a baseline, such that the information reflects a difference between the electrical signals and the baseline. As yet further examples, the processing system (110) may determine positional information, determine force information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

“Force information” as used herein is intended to broadly encompass force information regardless of format. For example, the force information may be provided for each object as a vector or scalar quantity. As another example, the force information may be provided as an indication that determined force has or has not crossed a threshold amount. As other examples, the force information can also include time history components used for gesture recognition. As will be described in greater detail below, positional information and force information from the processing systems may be used to facilitate a full range of interface inputs, including use of the proximity sensor device as a pointing device for selection, cursor control, scrolling, and other functions.

In some embodiments, the input device (100) is implemented with additional input components that are operated by the processing system (110) or by some other processing system. These additional input components may provide redundant functionality for input in the sensing region (120), or some other functionality. FIG. 1 shows buttons (130) near the sensing region (120) that may be used to facilitate selection of items using the input device (100). Other types of additional input components include sliders, balls, wheels, switches, and the like. Conversely, in some embodiments, the input device (100) may be implemented with no other input components.

In some embodiments, the input device (100) includes a touch screen interface, and the sensing region (120) overlaps at least part of an active area of a display screen. For example, the input device (100) may include substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device (100) and the display screen may share physical elements. For example, some embodiments may utilize some of the same electrical components for displaying and sensing. In various embodiments, one or more display electrodes of a display device may configured for both display updating and input sensing. As another example, the display screen may be operated in part or in total by the processing system (110).

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media that is readable by the processing system (110)). Additionally, the embodiments of the present invention apply equally regardless of the particular type of medium used to carry out the distribution. For example, software instructions in the form of computer readable program code to perform embodiments of the invention may be stored, in whole or in part, temporarily or permanently, on a non-transitory computer readable storage medium. Examples of non-transitory, electronically readable media include various discs, physical memory, memory, memory sticks, memory cards, memory modules, and or any other computer readable storage medium. Electronically readable media may be based on flash, optical, magnetic, holographic, or any other storage technology.

Although not shown in FIG. 1, the processing system, the input device, and/or the host system may include one or more computer processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), and numerous other elements and functionalities. The computer processor(s) may be an integrated circuit for processing instructions. For example, the computer processor(s) may be one or more cores, or micro-cores of a processor. Further, one or more elements of one or more embodiments may be located at a remote location and connected to the other elements over a network. Further, embodiments of the invention may be implemented on a distributed system having several nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

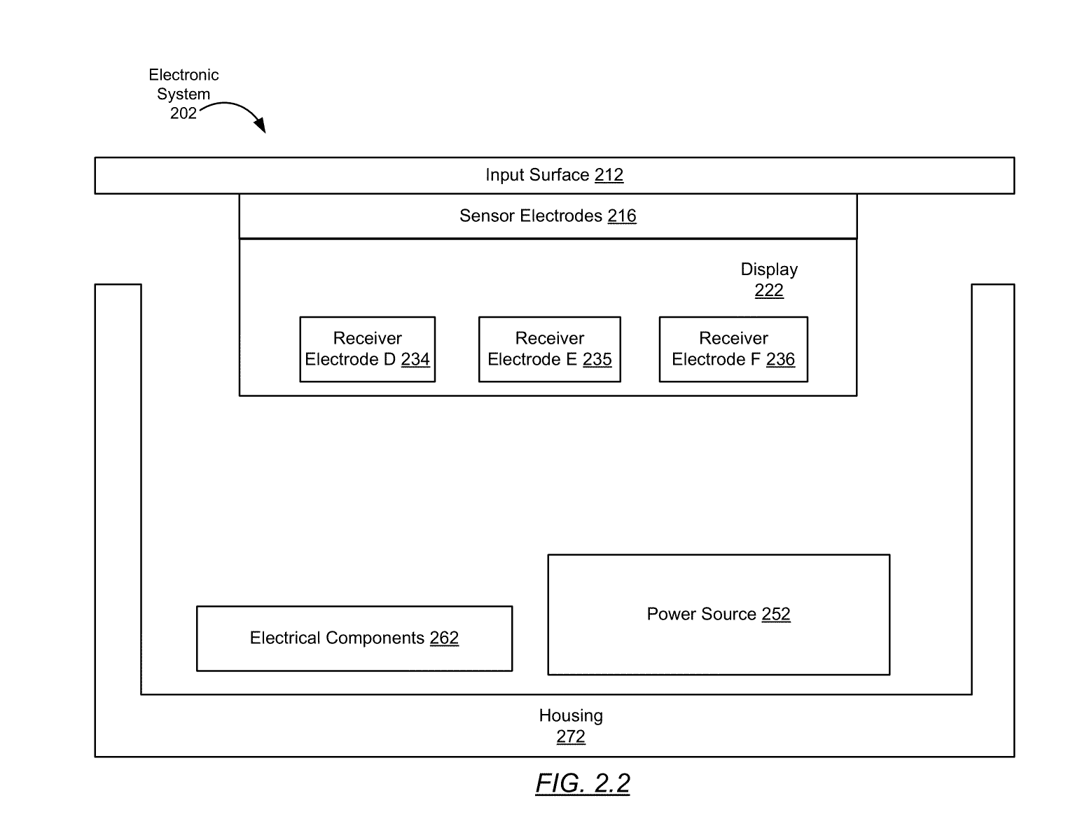

Turning to FIG. 2.1, FIG. 2.1 shows a schematic diagram in accordance with one or more embodiments. As shown in FIG. 2.1, an electronic system (201) may include various sensor electrodes (215) disposed underneath an input surface (211). The sensor electrodes (215) may be sensor electrodes similar to the sensor electrodes described in FIG. 1 and the accompanying description. For example, the sensor electrodes may include proximity sensors that include functionality to detect the location of one or more input objects. The input surface (211) may be an input surface as described in FIG. 1 and the accompanying description. For example, the input surface (211) may be a cover glass.

Furthermore, the electronic system (201) may include a display (221). For example, the display (221) may be a display screen. A display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. An input device implemented in the electronic system (201) may share physical elements with the display (221). For example, some embodiments may utilize some of the same electrical components for displaying and sensing. In various embodiments, one or more display electrodes of the display (221) may include functionality for both display updating and input sensing. In various embodiments, one or more of the sensor electrodes (215) may be electrodes of the display (221) used for both display updating and input sensing. As another example, the display (221) may be operated in part or in total by a processing system as shown in FIG. 1.

Keeping with FIG. 2.1, the electronic system (201) may further include various electrical components (261), a housing (271), and a power source (251). The electrical components (261) may include one or more circuit boards, such as a main board or printed circuit board assembly, that have various integrated circuits attached to the circuit boards. In another example, the electrical components (261) may include a processor, memory, and/or any other electrical devices for operating the electronic system. The housing (271) may provide an enclosure for components within the electronic system (201). For example, the housing (271) may be a casing made of metal or plastic. Likewise, a bezel (not shown) or other holder may be mounted to the housing (271), and which may support the input surface (211).

Furthermore, the power source (251) may be hardware that includes functionality to provide electrical power to the electrical components (261), the sensor electrodes (215), and a processing system (not shown). For example, the power source (251) may be a rechargeable battery with functionality to charge using an electric current obtained from an external power source connected to the electronic system (201).

In one or more embodiments, the electronic system (201) includes a backing substrate (241) disposed between various receiver electrodes (e.g., receiver electrode A (231), receiver electrode B (232), receiver electrode C (233)) and the housing (271). For example, the backing substrate (241) may be a conductive material configured as an interior support frame, as a midframe, for example, for the electronic system (201). Moreover, the backing substrate (241) may be a piece of sheet metal, such as a shielding can. In one or more embodiments, for example, the backing substrate (241) is a foil or plating layer attached to a non-conductive substrate. Accordingly, non-conductive substrate may be in a similar orientation as the backing substrate (241) as shown in FIG. 2.1.

In one or more embodiments, the backing substrate (241) is a reference voltage substrate. Specifically, a reference voltage substrate may include functionality to produce a reference voltage, such as a system ground, for capacitive coupling with the receiver electrodes (231, 232, 233). In one or more embodiments, the receiver electrodes (231, 232, 233) include functionality to measure a change in capacitance with the backing substrate (241). In particular, the capacitive coupling may vary in response to a deflection of the input surface (211) by an input force. Specifically, movement of one or more of the receiver electrodes (231, 232, 233) relative to the backing substrate (241) may result in a change in a variable capacitance formed between the receiver electrodes (231, 232, 233) and the backing substrate (241). A capacitance measurement (also called “capacitive measurement”) may be obtained that records the change in the variable capacitance, accordingly. These capacitance measurements correspond to the amount of force applied to the input surface (211).

Turning to FIG. 2.2, FIG. 2.2 shows a schematic diagram in accordance with one or more embodiments. As shown in FIG. 2.2, an electronic system (202) may include an input surface (212), electrical components (262), a power source (252), sensor electrodes (216), a housing (272), and a display (222) that includes various receiver electrodes (e.g., receiver electrode D (234), receiver electrode E (235), receiver electrode F (236)). However, unlike in FIG. 2.1, the electronic system (202) does not include a backing substrate. In one or more embodiments, the receiver electrodes (234, 235, 236) are capacitively coupled with components such as the power source (252) and/or electrical components (262). Specifically, in one or more embodiments, movement of one or more of the receiver electrodes (234, 235, 236) relative to the power source (252) may result in a change in a variable capacitance formed between the receiver electrodes (234, 235, 236) and the power source (252). Thus, the power source (252) may provide the reference voltage substrate for the receiver electrodes (234, 235, 236). In one or more embodiments, the electrical components (262) provide the reference voltage substrate for the receiver electrodes (234, 235, 236). A measurement of the change in the variable capacitance may be used by a processing system of the electronic system (202) to determine the amount of force applied to the input surface (212).

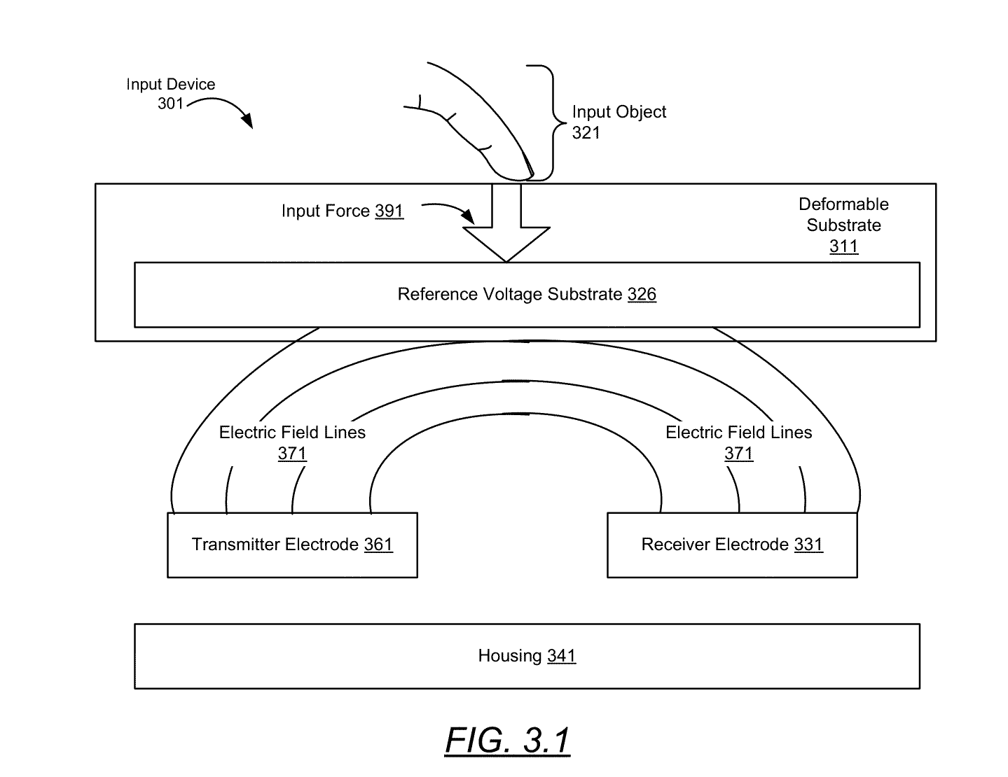

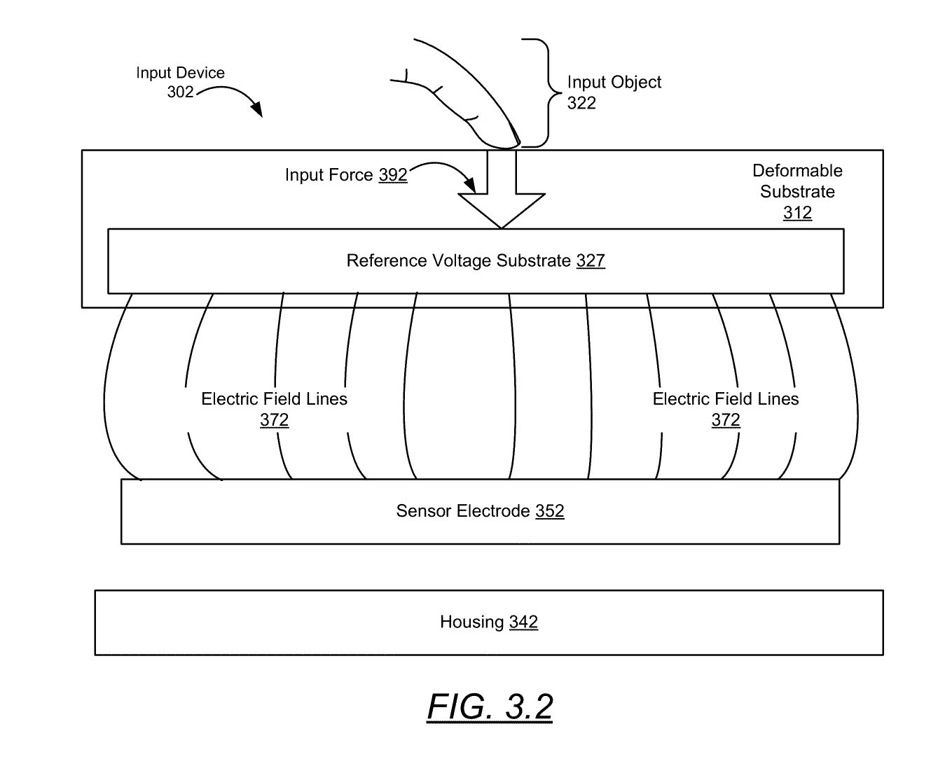

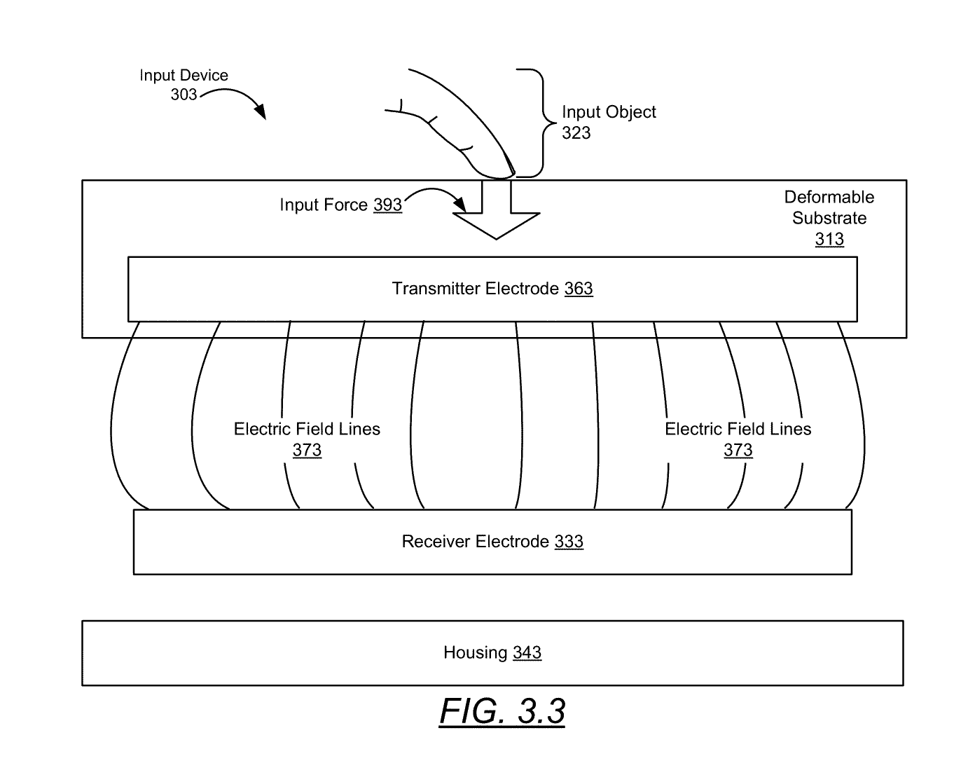

Turning to FIGS. 3.1, 3.2, and 3.3, FIGS. 3.1, 3.2, and 3.3 show schematic diagrams in accordance with one or more embodiments. As shown in FIG. 3.1, an input device (301) may include a deformable substrate (311), a housing (341), a transmitter electrode (361), and a receiver electrode (331). The deformable substrate (311) may include functionality to change shape or flex in response to an input force (391) applied by an input object (321). For example, the deformable substrate (311) may be an elastic and flexible material that deflects toward the housing (341) in response to the input force (391). In one or more embodiments, the deformable substrate (311) may be the display and input surface described in FIGS. 2.1-2.2 and the accompanying description.

Keeping with FIG. 3.1, the deformable substrate (311) may include a reference voltage substrate (326). The reference voltage substrate (326) may be conductive material that includes functionality to generate a reference voltage for capacitive coupling with the transmitter electrode (361) and the receiver electrode (331). The capacitive coupling illustrated, for example, by the electric field lines (371). Accordingly, the reference voltage substrate (326) may be ohmically coupled with a power source inside an electronics system. The reference voltage substrate (326) may be located on the surface of the deformable substrate (311) and/or disposed inside the deformable substrate (311). Moreover, the deformable substrate (311) may be a single layer or various discrete components of uniform or different sizes. Additionally, the reference voltage substrate (326) may be a component of a display used for display updating.

In one or more embodiments, the input device (301) of FIG. 3.1 is implemented within the electronic system of FIG. 2.1. In one or more embodiments, for example, the reference voltage substrate (326) is disposed in the display (221). Moreover, the transmitter electrode (361) and the receiver electrode (331) may be disposed separate from the display (221), for example, on the backing substrate (240) or in another substrate (not shown) in the electronic system (201).

Turning to FIG. 3.2, an input device (302) includes a deformable substrate (312), a housing (342), a sensor electrode (352), and a reference voltage substrate (327). The input device (302) may be disposed within electronic systems (201, 202) in a similar manner as described with respect to the input device (301) of FIG. 3.1. As shown in FIG. 3.2, capacitive coupling is illustrated, for example, by the electric field lines (372). Accordingly, an input force (392) applied by an input object (322) produces a change in variable capacitance between the sensor electrode (352) and the reference voltage substrate (327). In one or more embodiments, the reference voltage substrate (327) may be a component of the display used for display updating.

Turning to FIG. 3.3, an input device (303) includes a deformable substrate (313), a housing (343), a transmitter electrode (363), and a receiver electrode (333). The input device (303) may be disposed within electronic systems (201, 202) in a similar manner as described with respect to the input device (301) of FIG. 3.1. As shown in FIG. 3.3, capacitive coupling is illustrated, for example, by the electric field lines (373). Accordingly, an input force (393) applied by an input object (323) produces a change in variable capacitance between the transmitter electrode (363) and the receiver electrode (333). In one or more embodiments, the transmitter electrode (363) may be disposed on a display within the deformable substrate (313). In various embodiments, the transmitter electrode (363) may be a component of the display used for updating. In various embodiments, the transmitter electrode (363) may be a component of the input sensing system of the input device (303) (i.e. used to determine positional information of input objects in a sensing region of the input device).

While FIGS. 1, 2.1, 2.2, 3.1, 3.2, and 3.3 show various configurations of components, other configurations may be used without departing from the scope of the invention. For example, various components may be combined to create a single component. As another example, the functionality performed by a single component may be performed by two or more components.

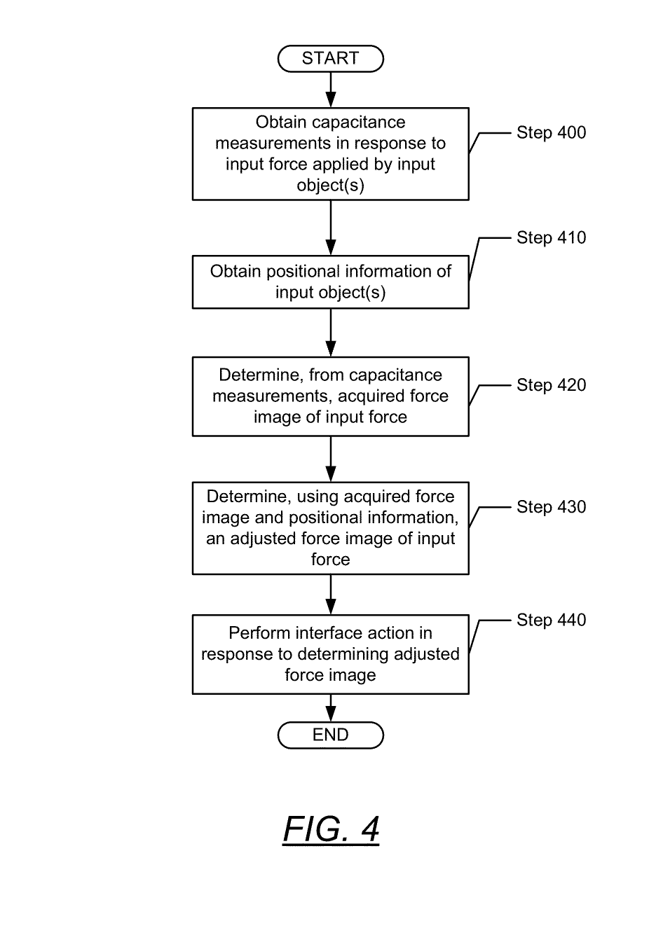

Turning to FIG. 4, FIG. 4 shows a flowchart in accordance with one or more embodiments. The process shown in FIG. 4 may involve, for example, one or more components discussed above in reference to FIGS. 1, 2.1, 2.2, 3.1, 3.2, and 3.3 (e.g., processing system (110)). While the various steps in FIG. 4 are presented and described sequentially, one of ordinary skill in the art will appreciate that some or all of the steps may be executed in different orders, may be combined or omitted, and some or all of the steps may be executed in parallel. Furthermore, the steps may be performed actively or passively.

In Step 400, various capacitance measurements are obtained in response to an input force applied by one or more input objects in accordance with one or more embodiments. In particular, the input force may be applied by an input object to an input surface as described in FIGS. 2.1 and 2.2 and the accompanying description. For example, the capacitance measurements may be obtained by force sensor electrodes similar to the receiver electrodes described in FIGS. 2.1, 2.2, 3.1, 3.2, and 3.3. The capacitance measurements may describe changes in absolute capacitance or mutual capacitance between the force sensor electrodes and a reference voltage substrate. In some embodiments, the capacitance measurements may be obtained when an input object is or is not detected in a sensing region of the input device.

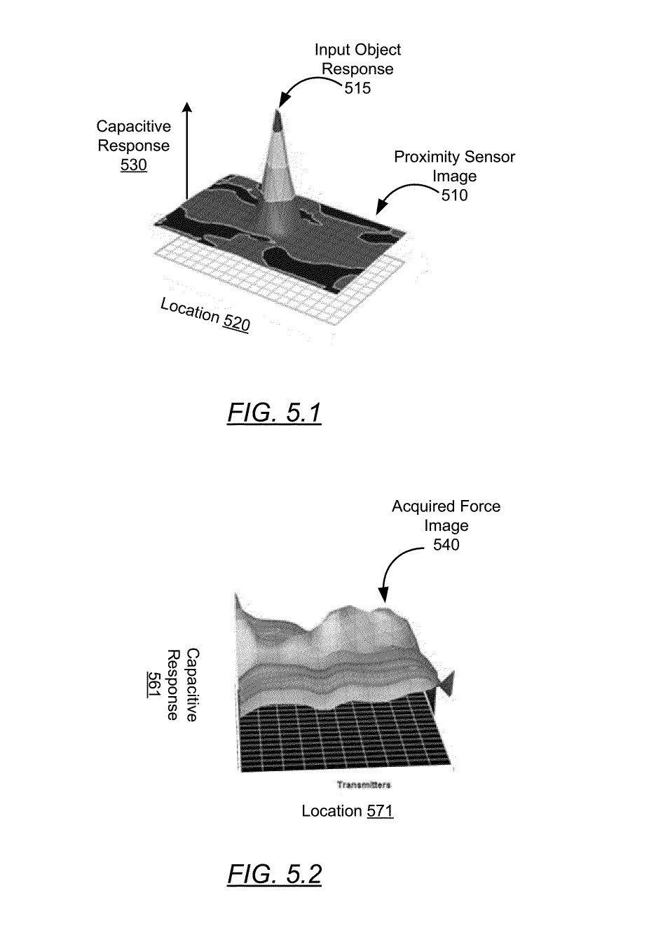

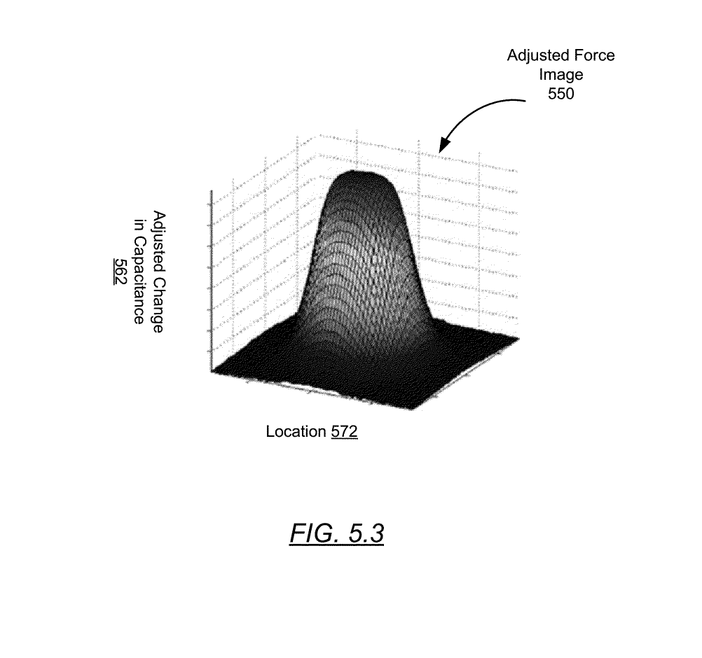

In Step 410, positional information of one or more input objects is obtained in accordance with one or more embodiments. In particular, the positional information may be obtained using proximity sensors similar to the sensor electrodes described in FIG. 1 and sensor electrodes (215) of FIG. 2.1. Furthermore, the positional information may correspond to x and y coordinates within a sensing region of an input device. For example, a proximity sensor image may capture a change in variable capacitance in a sensing region. The positional information may define a central location of the input object in a sensing region. For an example of a proximity sensor image, see FIG. 5.1 and the accompanying description below.

In Step 420, an acquired force image of an input force is determined from various capacitance measurements in accordance with one or more embodiments. Using the capacitive measurements obtained in Step 400, for example, an acquired force image may be produced. The acquired force image may describe capacitive measurements obtained at various receiver electrodes in an input device. For an example of an acquired force image, see FIG. 5.2 and the accompanying description below.

In Step 430, an adjusted force image of an input force is determined using positional information and an acquired force image in accordance with one or more embodiments. Using the positional information from Step 410, for example, an image adjustment may be determined for the acquired force image from Step 420. This image adjustment may provide a particular correction used to produce the adjusted force image. In one or more embodiments, for example, the image adjustment may be an image adjustment value obtained from a lookup table. On the other hand, in one or more embodiments, the image adjustment is obtained using a function or algorithm that computes image adjustment values for the acquired force image. In one or more embodiments, the lookup table designates a magnitude of force using the acquired force image and the positional information without producing an adjusted force image.

Turning to FIGS. 5.1, 5.2, and 5.3, FIGS. 5.1, 5.2, and 5.3 provide examples of capacitance images. The following examples are for explanatory purposes only and not intended to limit the scope of the invention.

Turning to FIG. 5.1, a proximity sensor image (510) is shown. The proximity image may be a capacitance image with a vertical axis that illustrates a capacitive response (530). In particular, the capacitive response (530) may correspond to capacitance measurements as obtained by sensor electrodes (215), for example. Moreover, the capacitive response (530) may be a function of location (520) within a sensing region as represented by the horizontal axes of FIG. 5.1. As shown, an input object response (515) produced by an input object in a sensing region is illustrated as a discrete bump in the proximity sensor image (510).

Turning to FIG. 5.2, an acquired force image (540) is shown. The acquired force image (540) may represent a capacitive response (561) obtained by various sensor electrodes and correspond to the vertical axis of FIG. 5.2. Likewise, capacitive response (561) may be a function of the location (571) of the sensor electrodes within a sensing region as represented by the horizontal axis of FIG. 5.2. Furthermore, the acquired force image (540) may be the capacitance image obtained from various receiver electrodes of an input device in response to an input force applied to an input surface of the input device.

Turning to FIG. 5.3, an adjusted force image (550) is shown. The acquired force image (540) may represent an adjusted change in capacitance (562) shown by the vertical axis of FIG. 5.2. Likewise, the adjusted change in capacitance (562) may be a function of the location (572) of the sensor electrodes within a sensing region as represented by the horizontal axes of FIG. 5.3. Furthermore, the adjusted force image (550) may be a capacitance image generated from the acquired force image (540) from FIG. 5.2 using an image adjustment based on the location of an input object determined from the proximity sensor image (510) from FIG. 5.1.

Returning to FIG. 4, in Step 440, an interface action is performed in response to determining an adjusted force image in accordance with one or more embodiments. In particular, an input device may determine commands and/or signals in response to determining the adjusted force image from Step 430. In one or more embodiments, for example, the adjusted force image is used to determine a magnitude of force applied to an input surface. For example, a processing system may determine the magnitude of the force as a quantity of Newtons and/or other force quantity.

Moreover, the amount of force computed from the adjusted force image may trigger different types of commands and/or signals by an input device. Subsequently, these commands and/or signals may trigger different types of interface actions within a graphical user interface within a display. Interface actions may include activities that produce changes in a graphical user interface and/or modifications to data sources presented within the graphical user interface. In one or more embodiments, for example, the commands and/or signals may trigger various actions such as haptic responses, actuators, audio responses, and/or any other actions performed by an electronic device. Moreover, the triggered actions may be determined based on the context of a graphical user interface. The triggered actions may also be based on position characteristics and/or force characteristics with or without relation to a graphical user interface.

In one or more embodiments, different interface actions are generated in response to detecting different types of input forces applied by an input object to an input surface. In one or more embodiments, an interface actions includes a content manipulation action by a user with respect to content provided by a graphical user interface. In one or more embodiments, for example, a content manipulation action includes copying, moving, dragging, and cutting the content from one location within the graphical user interface.

In one or more embodiments, the interface action includes a window manipulation action with respect to the GUI windows disposed in the graphical user interface. For example, a window manipulation action may maximize or minimize a window within a graphical user interface. In another example, a window manipulation action may align the window to a left-side (i.e., a “snap left” action) or to the right-side (i.e., a “snap right” action) on the screen of a display.

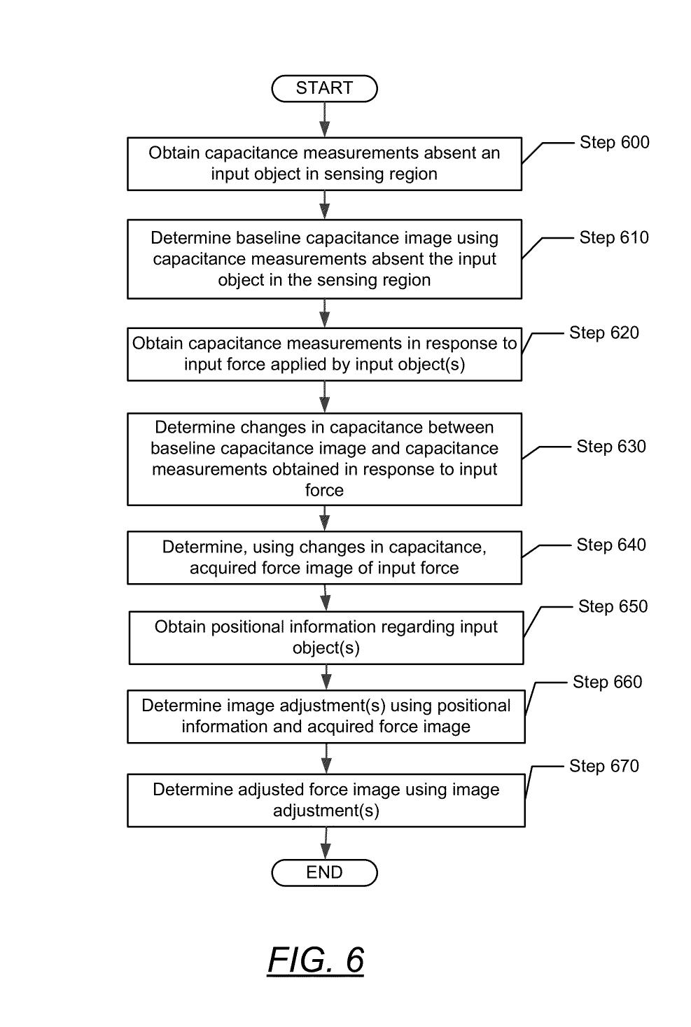

Turning to FIG. 6, FIG. 6 shows a flowchart in accordance with one or more embodiments. The process shown in FIG. 6 may involve, for example, one or more components discussed above in reference to FIGS. 1, 2.1, 2.2, 3.1, 3.2, and 3.3 (e.g., processing system (110)). While the various steps in FIG. 6 are presented and described sequentially, one of ordinary skill in the art will appreciate that some or all of the steps may be executed in different orders, may be combined or omitted, and some or all of the steps may be executed in parallel. Furthermore, the steps may be performed actively or passively.

In Step 600, various capacitance measurements are obtained absent an input object in a sensing region in accordance with one or more embodiments. In particular, the capacitance measurements may be obtained in a similar manner as described in Step 400 above. The capacitance measurements in Step 600 may be baseline measurements for a baseline capacitance image determined in Step 610 below. Furthermore, a processing system may use sensor electrodes (e.g. sensor electrodes (215)) to detect whether any input objects are located in the sensing region. If no input objects are detected in the sensing region, then the processing system may obtain capacitance force measurements from various receiver electrodes (e.g. receiver electrodes 234, 235 and 236) or sensor electrodes (e.g. sensor electrode 352 or receiver electrode 333) in response to the detection.

In Step 610, a baseline capacitance image is determined using capacitance measurements absent an input object in a sensing region in accordance with one or more embodiments. Using the capacitance measurements obtained in Step 600, for example, a processing system may obtain a capacitance image that is unaffected by input objects or any applied input forces. Thus, the baseline capacitance image may provide a metric for determining changes in variable capacitance between the receiver electrodes and a reference voltage substrate or transmitter electrode.

In Step 620, various capacitance measurements are obtained in response to an input force applied by one or more input objects in accordance with one or more embodiments. When an input object enters a sensing region and applies an input force to an input device, capacitance measurements may be obtained from various receiver electrodes in the input device. In particular, the capacitance measurements may be obtained in a similar manner as described in Step 400 and the accompanying description above.

In Step 630, changes in capacitance are determined between a baseline capacitance image and capacitance measurements obtained in response to an input force in accordance with one or more embodiments. In one or more embodiments, for example, a processing system compares capacitance measurements from the baseline capacitance image determined in Step 610 with the capacitance measurements obtained in Step 630. Based on this comparison, differences between each set of capacitance measurements may be calculated accordingly.

In Step 640, an acquired force image of an input force is determined using changes in capacitance in accordance with one or more embodiments. Specifically, the acquired force image may describe the differences between capacitance measurements of the baseline capacitance image and the capacitance measurements determined in Step 630. Thus, the acquired force image may provide a raw capacitance image that shows one or more effects of an input force applied to an input device, e.g., at an input surface.

In Step 650, positional information is obtained regarding one or more input objects in accordance with one or more embodiments. In particular, the positional information may describe the location within a sensing region of the input object(s) that applied the input force in Step 620. For example, a processing system may identify where the input object is located in a two-dimensional grid that describes the sensing region.

In Step 660, one or more image adjustments are determined using positional information and acquired force image in accordance with one or more embodiments. In one or more embodiments, the image adjustment is a scalar value that determines how a particular capacitance measurement may be adjusted to produce an adjusted force image. Using the image adjustments, for example, the processing system may adjust the acquired force image in order to remove effects of electrical noise and/or non-uniform capacitive coupling to various components in an electronic system.

In one or more embodiments, for example, a lookup table is used to determine the image adjustment for the acquired force image. Specifically, the lookup table may be a set of data values that designate different amounts of adjustment. For example, with the same acquired force image, different position coordinates of an input object may produce different image adjustment values from the lookup table. In particular, the set of data values in the lookup table may be collected in a factory or manufacturing facility. Different lookup tables may be used for different input devices or different types of input devices with different designs. Data values in the lookup table may be determined, for example, by applying a known force to an input surface of an input device at a known location and measuring the resulting capacitive measurement. This process may be repeated for various locations and various forces on the input device.

In one or more embodiments, for example, an adjustment function is used to determine the image adjustment for the acquired force image. In particular, positional information corresponding to a location of an input object may provide data inputs to the adjustment function. Values of the acquired force image may provide other data inputs to the adjustment function. Accordingly, the output of the adjustment function may be the adjusted force image.

In Step 670, an adjusted force image is determined using one or more image adjustments and an acquired force image in accordance with one or more embodiments. After one or more image adjustments are obtained in Step 660, the image adjustments may be applied to the acquired force image from Step 640 to produce the adjusted force image. Moreover, force information may be computed using the adjusted force image. Thus, the computed force information may be used by a processing system, for example, to determine a command or signal for a display or other electrical component.

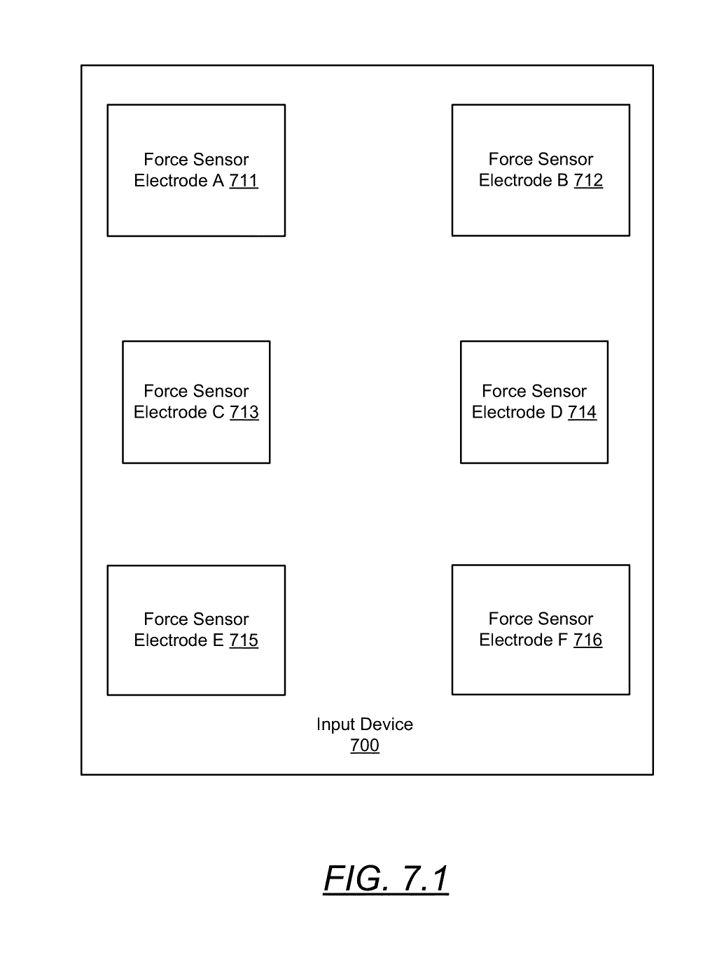

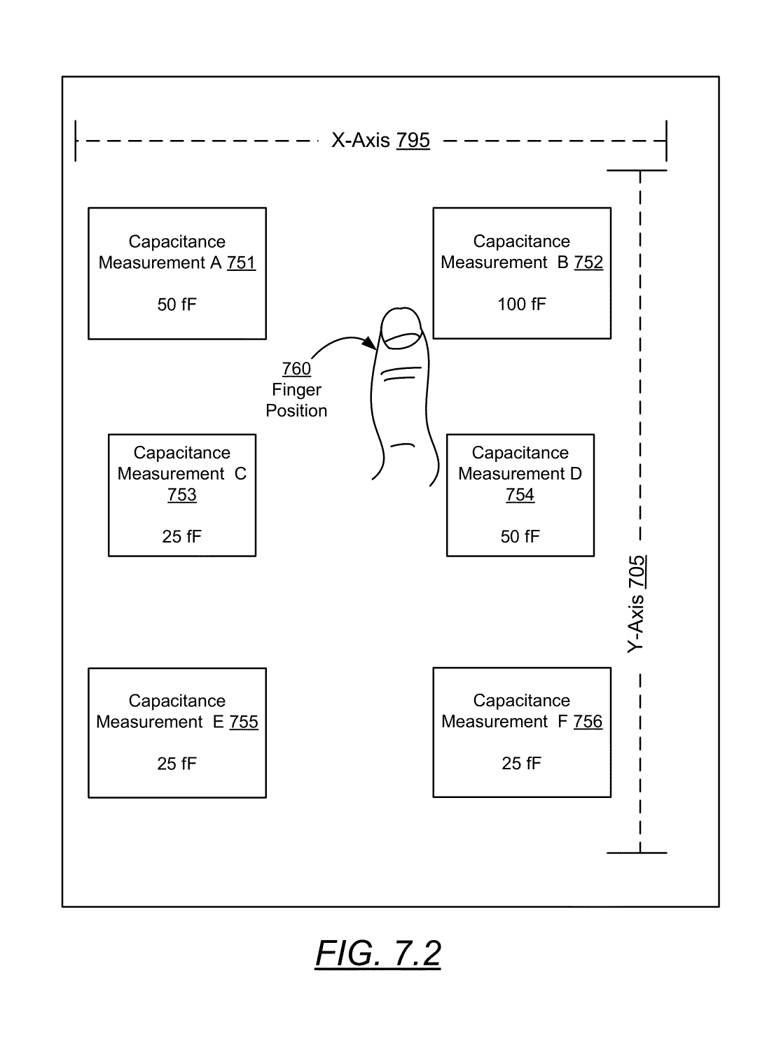

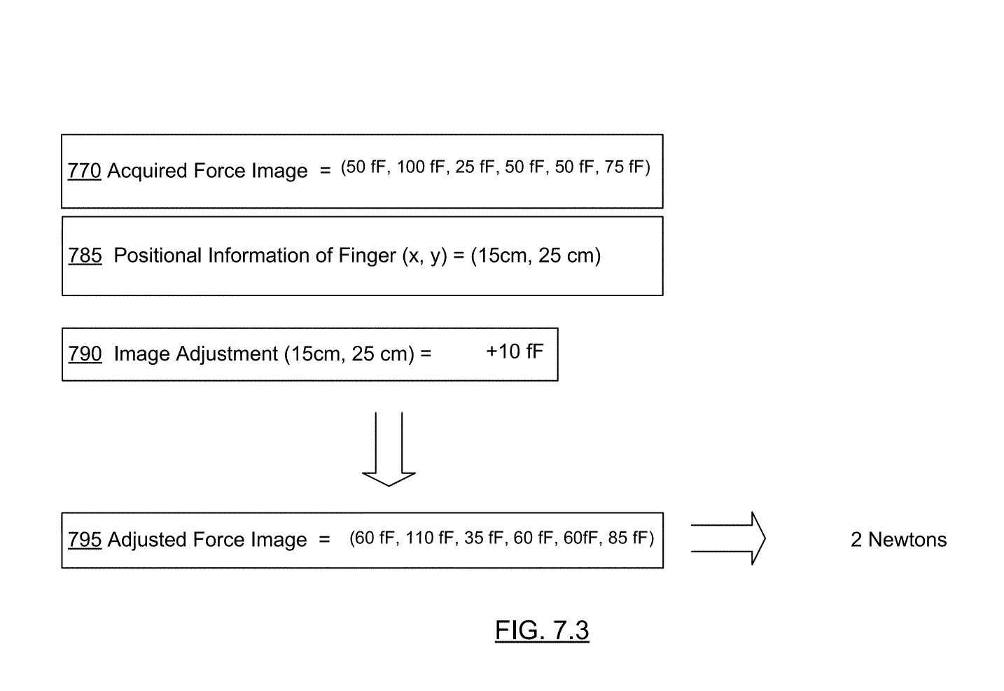

Turning to FIGS. 7.1, 7.2, and 7.3, FIGS. 7.1, 7.2, and 7.3 provide an example of determining an adjusted force image. The following example is for explanatory purposes only and not intended to limit the scope of the invention.

Turning to FIG. 7.1, an input device (700) is shown with various force sensor electrodes (e.g., force sensor electrode A (711), force sensor electrode B (712), force sensor electrode C (713), force sensor electrode D (714), force sensor electrode E (715), and force sensor electrode F (716)). As shown in FIG. 7.2, various capacitance measurements (e.g., capacitance measurement A (751), capacitance measurement B (752), capacitance measurement C (753), capacitance measurement D (754), capacitance measurement E (755), capacitance measurement F (756)) are obtained in response to an input force applied by a finger to the input device (700). The input device (700) also detects the finger position (760) with respect to an x-axis (795) and a y-axis (705), by using for example sensor electrodes (215). As shown in FIG. 7.3, an acquired force image (770) is generated that includes the capacitance measurements (751, 752, 753, 754, 755, 756). Using positional information of the finger (785), an image adjustment (790) is calculated. The image adjustment (790) is then applied to the acquired force image (770) to produce an adjusted force image (795). Accordingly, a processing system uses the adjusted force image (795) to determine the magnitude of the input force applied by the finger to be 2 Newtons.

Embodiments may be implemented on a computing system. Any combination of mobile, desktop, server, router, switch, embedded device, or other types of hardware may be used. For example, as shown in FIG. 8.1, the computing system (800) may include one or more computer processors (802), non-persistent storage (804) (e.g., volatile memory, such as random access memory (RAM), cache memory), persistent storage (806) (e.g., a hard disk, an optical drive such as a compact disk (CD) drive or digital versatile disk (DVD) drive, a flash memory, etc.), a communication interface (812) (e.g., Bluetooth interface, infrared interface, network interface, optical interface, etc.), and numerous other elements and functionalities.

The computer processor(s) (802) may be an integrated circuit for processing instructions. For example, the computer processor(s) may be one or more cores or micro-cores of a processor. The computing system (800) may also include one or more input devices (810), such as a touchscreen, keyboard, mouse, microphone, touchpad, electronic pen, or any other type of input device.

The communication interface (812) may include an integrated circuit for connecting the computing system (800) to a network (not shown) (e.g., a local area network (LAN), a wide area network (WAN) such as the Internet, mobile network, or any other type of network) and/or to another device, such as another computing device.

Further, the computing system (800) may include one or more output devices (808), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (802), non-persistent storage (804), and persistent storage (806). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (800) in FIG. 8.1 may be connected to or be a part of a network. For example, as shown in FIG. 8.2, the network (820) may include multiple nodes (e.g., node X (822), node Y (824)). Each node may correspond to a computing system, such as the computing system shown in FIG. 8.1, or a group of nodes combined may correspond to the computing system shown in FIG. 8.1. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (800) may be located at a remote location and connected to the other elements over a network.

Although not shown in FIG. 8.2, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (822), node Y (824)) in the network (820) may be configured to provide services for a client device (826). For example, the nodes may be part of a cloud computing system. The nodes may include functionality to receive requests from the client device (826) and transmit responses to the client device (826). The client device (826) may be a computing system, such as the computing system shown in FIG. 8.1. Further, the client device (826) may include and/or perform all or a portion of one or more embodiments of the invention.

The computing system or group of computing systems described in FIGS. 8.1 and 8.2 may include functionality to perform a variety of operations disclosed herein. For example, the computing system(s) may perform communication between processes on the same or different systems. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until the server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system performing one or more embodiments of the invention may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the invention, may extract one or more data items from the obtained data. For example, the extraction may be performed as follows by the computing system (800) in FIG. 8.1. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail—such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 8.1, while performing one or more embodiments of the invention, may perform data comparison. Data comparison may be used to compare two or more data values (e.g., A, B). For example, one or more embodiments may determine whether A>B, A=B, A !=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the invention, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 8.1 may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 8.1 may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions present only a few examples of functions performed by the computing system of FIG. 8.1 and the nodes and/or client device in FIG. 8.2. Other functions may be performed using one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A processing system for an input device, the processing system comprising:
sensor circuitry communicatively coupled to a plurality of position sensor electrodes, a first force sensor electrode, and a second force sensor electrode;
a sensor module configured to:
obtain a first capacitance measurement from the first force sensor electrode and a second capacitance measurement from the second force sensor electrode,
wherein the first capacitance measurement and the second capacitance measurement correspond to changes in a variable capacitance in response to a deflection of the first force sensor electrode and the second force sensor electrode by an input force,
wherein the input force is applied by at least one input object to an input surface of the input device, and
obtain, from the plurality of position sensor electrodes, positional information of the at least one input object in a sensing region of the input device; and
a determination module configured to:
determine, using the first capacitance measurement and the second capacitance measurement, an acquired force image of the input force, and
determine, using the acquired force image and the positional information, an adjusted force image of the input force.

2. The processing system of claim 1,
wherein the positional information comprises a first position coordinate and a second position coordinate that correspond to a location of the at least one input object in the sensing region of the input device, and
wherein the adjusted force image is determined using an adjustment function comprising a first input using the first position coordinate and a second input using the second position coordinate.

3. The processing system of claim 1,
wherein the adjusted force image is determined using a lookup table that determines an adjusted force magnitude of the adjusted force image in response to an acquired force magnitude from the acquired force image.

4. The processing system of claim 1,
wherein the sensor module is further configured to:
obtain a third capacitance measurement from the first force sensor electrode and a fourth capacitance measurement regarding the second force sensor electrode,
wherein the third capacitance measurement and the fourth capacitance measurement are obtained when no input object is located in the sensing region of the input device; and
wherein the determination module is further configured to:
determine, using the third capacitance measurement and the fourth capacitance measurement, a baseline capacitance image of the input force.

5. The processing system of claim 4,
wherein the determination module is further configured to:
determine, using the baseline capacitance image, the first capacitance measurement, and the second capacitance measurement, a first adjusted capacitance measurement and a second adjusted capacitance measurement,
wherein the adjusted force image is determined using the first adjusted capacitance measurement and the second adjusted capacitance measurement.

6. The processing system of claim 1,
wherein the first capacitance measurement corresponds a change in variable capacitance between the first force sensor electrode and a reference voltage produced using a backing substrate inside the input device, and
wherein the backing substrate is disposed between a power source and the first force sensor electrode.

7. The processing system of claim 1,
wherein the first capacitance measurement corresponds a change in variable capacitance between the first force sensor electrode and a reference voltage, and
wherein the reference voltage is produced by a power source inside an electronic system comprising the input device.

8. An electronic system, comprising:
a display configured to present information to a user;
an input surface;
an input device comprising a plurality of position sensor electrodes, a first force sensor electrode, and a second force sensor electrode; and
a processing system communicatively coupled to the display and the input device, the processing system configured to:
obtain a first capacitance measurement from the first force sensor electrode and a second capacitance measurement from the second force sensor electrode,
wherein the first capacitance measurement and the second capacitance measurement correspond to changes in a variable capacitance in response to a deflection of the first force sensor electrode and the second force sensor electrode by an input force,
wherein the input force is applied by at least one input object to the input surface, and
obtain, from the plurality of position sensor electrodes, positional information of the at least one input object in a sensing region of the input device,
determine, using the first capacitance measurement and the second capacitance measurement, an acquired force image of the input force, and
determine, using the acquired force image and the positional information, an adjusted force image of the input force.

9. The electronic system of claim 8,
wherein the positional information comprises a first position coordinate and a second position coordinate that correspond to a location of the at least one input object in the sensing region of the input device, and
wherein the adjusted force image is determined using an adjustment function comprising a first input using the first position coordinate and a second input using the second position coordinate.

10. The electronic system of claim 8,
wherein the adjusted force image is determined using a lookup table that determines an adjusted force magnitude of the adjusted force image in response to an acquired force magnitude from the acquired force image.

11. The electronic system of claim 8,
wherein the processing system is further configured to:
obtain a third capacitance measurement from the first force sensor electrode and a fourth capacitance measurement regarding the second force sensor electrode,
wherein the third capacitance measurement and the fourth capacitance measurement are obtained when no input object is located in the sensing region of the input device, and
determine, using the third capacitance measurement and the fourth capacitance measurement, a baseline capacitance image of the input force.

12. The electronic system of claim 11,
wherein the processing system is further configured to:
determine, using the baseline capacitance image, the first capacitance measurement, and the second capacitance measurement, a first adjusted capacitance measurement and a second adjusted capacitance measurement,
wherein the adjusted force image is determined using the first adjusted capacitance measurement and the second adjusted capacitance measurement.

13. The electronic system of claim 8,
wherein the display device comprises a conductive layer configured to produce a reference voltage, and
wherein the first capacitance measurement corresponds a change in variable capacitance between the first force sensor electrode and the reference voltage.

14. The electronic system of claim 8, further comprising:
a power source,
wherein the input device comprises a backing substrate disposed between the first force sensor electrode and the power source,
wherein the backing substrate is a conductive material configured to produce a reference voltage, and
wherein the first capacitance measurement corresponds a change in variable capacitance between the first force sensor electrode and the reference voltage.

15. The electronic system of claim 8, further comprising:
a power source configured to produce a reference voltage,
wherein the first capacitance measurement corresponds a change in variable capacitance between the first force sensor electrode and the reference voltage.

16. The electronic system of claim 8, wherein the input device is located inside the display.

17. An input device, comprising:
an input surface;
a plurality of sensor electrodes configured to detect positional information of at least one input object in a sensing region of the input device;
a first sensor electrode configured to detect a first change in a first variable capacitance in response to a deflection of a conductive layer by at least one input object; and
a second sensor electrode configured to detect a second change in a second variable capacitance in response to the deflection of the conductive layer by the at least one input object,
wherein the first change in the first variable capacitance and the second change in the second variable capacitance are configured to determine an acquired force image of the input force, and
wherein the acquired force image is configured for determining an adjusted force image using the positional information.

18. The input device of claim 17, further comprising:
a backing substrate disposed between the first force sensor electrode and a power source,
wherein the backing substrate is a conductive material configured to produce a reference voltage, and
wherein the first capacitance measurement corresponds a change in variable capacitance between the first force sensor electrode and the reference voltage.

19. The input device of claim 17, further comprising:
a power source configured to produce a reference voltage,
wherein the first capacitance measurement corresponds a change in variable capacitance between the first force sensor electrode and the reference voltage.
